(19) United States
(12) Patent Application Publication
(10) Pub. No.: US 2024/0066702 A1
(43) Pub. Date: Feb. 29, 2024

(54) METHOD OF HANDLING SAFETY OF INDUSTRIAL ROBOT, AND SYSTEM

(71) Applicant: ABB Schweiz AG, Baden (CH)

(72) Inventors: Mikael Norrlöf, Norrköping (SE); Arne Wahrburg, Weiterstadt, HE (DE); Debora Clever, Zwingenberg (DE); Nima Enayati, Mannheim (DE); Jonas Haulin, Shanghai, Pudong New Area (CN); Mattias Björkman, Västerås (SE); Giacomo Spampinato, Västerå (SE)

(21) Appl. No.: 18/261,156

(22) PCT Filed: Jan. 21, 2021
(86) PCT No.: PCT/EP2021/051288

§ 371 Date: Jul. 12, 2023

(51) Int. Cl. B25J 9/16; B25J 13/00; B25J 19/06

(52) U.S. Cl. CPC B25J 9/1674; B25J 9/1605; B25J 9/1664; B25J 13/006; B25J 19/06

(57) ABSTRACT

A method of handling safety of an industrial robot in a workspace, the method including providing a geometric region by a monitoring system, where the geometric region is defined in relation to the industrial robot and/or in relation to the workspace, and where the geometric region is associated with at least one condition for being fulfilled by the industrial robot; communicating the geometric region from the monitoring system to a robot control system of the industrial robot; determining a movement of the industrial robot by the robot control system based on the geometric region and the at least one condition; executing the movement by the industrial robot; and monitoring, by the monitoring system, the execution of the movement with respect to the geometric region and the at least one condition.

### TECHNICAL FIELD

The present disclosure generally relates to handling safety of an industrial robot. In particular, a method of handling safety of an industrial robot in a workspace, and a system for handling safety of an industrial robot in a workspace, are provided.

### BACKGROUND

A robot system may comprise one or several industrial robots operating in a workspace. In some robot systems, the workspace is enclosed by a physical fence to protect humans from the one or more industrial robots.

As an alternative to a physical fence, some robot systems comprise a monitoring system. The monitoring system may use various supervision functions to supervise the industrial robots in the workspace to ensure a high safety level. In case a safety configuration set in the monitoring system is violated by the industrial robot, the monitoring system can automatically stop the industrial robot to avoid an accident. The monitoring system may also report the violation. An example of such violation is when the industrial robot moves faster than a maximum speed defined in the monitoring system.

When an external monitoring system has intervened to stop an industrial robot, the process of getting the industrial robot up and running again might be cumbersome. The industrial robot may for example have to be restarted. This affects process quality and cycle times in the workspace negatively. It is therefore desired to avoid triggering of such interventions.

SE 1500299 A1 discloses an industrial robot safety system and a method for avoiding collisions between moving parts of two manipulators, or between a moving part of a manipulator and an object close to the manipulator. A robot system comprises a manipulator and a robot controller for controlling the movements and actions of the moving parts of the manipulator. The robot controller comprises a collision avoidance system and a trajectory planning system. The robot system further comprises a safety controller working in parallel with the collision avoidance system of the robot controller. The method comprises different steps of exchanging information about the planned trajectory of the moving parts of the respective manipulator in order to prevent collisions between the moving parts or between a moving part and an object.

US 2019105779 A1 discloses a robotic system comprising a control unit controlling robots, and a motion tracking system including imaging devices. Safety envelopes are dynamically determined in a task cell.

Reference 1 describes safety in human-robot collaborative (HRC) manufacturing environments. Reference 1 shows a HRC assembly station. Reference 1 mentions a robot controller and an external PC. Reference 1 further mentions interaction zones in which direct contact between the robot and the human might occur.

Reference 1: ZANCHETTIN ANDREA MARIA ET AL: “Safety in Human-Robot Collaborative Manufacturing Environments: Metrics and Control”, IEEE TRANSACTIONS ON AUTOMATION SCIENCE AND ENGINEERING, IEEE SERVICE CENTER, NEW YORK, NY, US, vol. 13, no. 2, 1 Apr. 2016 (2016 Apr. 1), pages 882-893, XP011605470, ISSN: 1545-5955, DOI: 10.1109/TASE.2015.2412256

In prior art solutions, the robot controller is not aware of the safety configuration. It is therefore up to the robot programmer to create a robot program that does not violate the safety configuration. This takes a significant time and is also difficult to verify. In case the safety configuration is changed, the robot programmer needs to manually update the robot program to comply with the new safety configuration.

### SUMMARY

One object of the present disclosure is to provide a method of efficiently handling safety of an industrial robot in a workspace.

A further object of the present disclosure is to provide a method of handling safety of an industrial robot in a workspace, which method reduces downtime in the workspace.

A still further object of the present disclosure is to provide a method of handling safety of an industrial robot in a workspace, which method enables a change in a safety configuration provided by a monitoring system to be more effectively met by the industrial robot.

A still further object of the present disclosure is to provide a method of handling safety of an industrial robot in a workspace, which method provides a high ease of use for a robot programmer.

A still further object of the present disclosure is to provide a method of handling safety of an industrial robot in a workspace, which method solves several or all of the foregoing objects in combination.

A still further object of the present disclosure is to provide a system for handling safety of an industrial robot in a workspace, which system solves one, several or all of the foregoing objects.

According to a first aspect, there is provided a method of handling safety of an industrial robot in a workspace, the method comprising providing a geometric region by a monitoring system, where the geometric region is defined in relation to the industrial robot and/or in relation to the workspace, and where the geometric region is associated with at least one condition for being fulfilled by the industrial robot; communicating the geometric region from the monitoring system to a robot control system of the industrial robot; determining a movement of the industrial robot by the robot control system based on the geometric region and the at least one condition; executing the movement by the industrial robot; and monitoring, by the monitoring system, the execution of the movement with respect to the geometric region and the at least one condition.

The monitoring system provides safety supervision of the workspace. The monitoring system may be a certified safety control system configured to perform a certified safety check of movements of the industrial robot, for example of several or all movable links of the industrial robot. The monitoring system may provide supervision functions that can intervene to stop the industrial robot if a safety configuration is violated by the industrial robot.

The method is based on the idea of sharing the safety configuration determined by the monitoring system with one or more industrial robots in the workspace. The safety configuration comprises one or more geometric regions and optional further information. The geometric regions may be static geometric regions. The geometric region forms a basis for the determination of the movement by the robot control system. The communication of the geometric region from the monitoring system to the robot control system does however not alter the main function of the monitoring system of monitoring the execution of the movements by the industrial robot with respect to the safety configuration.

By communicating the geometric region from the monitoring system to the robot control system, path programming of the industrial robot becomes more effective. For example, it can more easily be prevented that paths or trajectories violate conditions associated with the geometric region. In this way, it can be avoided that the monitoring system intervenes to stop the industrial robot. Downtime of the industrial robot can thereby be avoided or reduced. Moreover, by communicating the geometric region from the monitoring system to the robot control system to thereby let the robot control system handle the geometric region and the at least one associated condition, it is possible to change a geometric region, and/or a condition associated with the geometric region, without having to manually update a robot program in the robot control system.

The determination of the movement of the industrial robot based on the geometric region and the at least one condition may be performed automatically by the robot control system. The robot control system may for example be a robot controller.

A planner implemented in the robot control system may use the geometric region as communicated by the monitoring system. The planner may be a path planner or a trajectory planner. In this way, the robot control system can avoid stops due to triggering of a safety reaction by the monitoring system. Moreover, the robot programmers do not explicitly have to consider the safety configuration in detail when setting up and changing the application software and robot program. The method thus enables the safety configuration to be separated from the programming and integration.

If a speed-limiting geometric region is reduced in size, the method enables a fast and simple modification of the robot program to make use of regions without constraints. In this way, productivity of the industrial robot can be effectively increased.

The method further enables changes in an already implemented safety configuration for a workspace, such as introduction of additional conditional geometric regions, to be effectively handled by the robot control system. Since the robot control system always determines movements of the industrial robot based on the latest updated geometric regions and associated conditions, as communicated by the monitoring system, the industrial robot can actively adapt to the updated safety configuration such that the risk that the industrial robot violates the safety configuration is reduced. At the same time, the performance of the industrial robot can be maximized, given the constraints of the safety configuration. This improves productivity of the industrial robot.

The geometric region may be communicated from the monitoring system to the robot control system “without safety”. That is, the communication of the safety configuration from the monitoring system to the robot control system does not have to be safety rated.

The method may comprise providing a plurality of geometric regions where each geometric region is associated with at least one condition to be met by the industrial robot. Each geometric region may for example be a two-dimensional or three-dimensional zone in the workspace. Each geometric region may provide a virtual barrier in the workspace.

The conditions may be of various types. When a condition is triggered, a constraint may be imposed on the industrial robot. According to one example, the industrial robot is speed limited within the geometric region. According to a further example, the industrial robot is speed limited when an object other than the industrial robot appears in the geometric region, regardless of whether or not the industrial robot is within the geometric region. According to a further example, the industrial robot is speed limited only when the industrial robot is within the geometric region and an object appears within the geometric region. In this variant, the industrial robot may operate at full speed, or a higher speed, outside the geometric region. According to a further example, the condition forbids the industrial robot to enter the geometric region. The geometric region may thus be a forbidden zone.

The industrial robot may comprise a manipulator programmable in three or more axes, such as six or seven axes. The industrial robot may be a mobile robot, may be fixed to the ground or may be movable along a track.

The movement of the industrial robot may be a movement of one or more parts of the industrial robot. The part may be a tool or a TCP (tool center point) of the manipulator or a base of the industrial robot (e.g. in the case of a mobile robot).

The at least one condition associated with a geometric region may be triggered or activated when a part of the industrial robot is within the geometric region. This part may for example be a tool or a TCP of the manipulator.

The method may further comprise providing the at least one condition by the monitoring system; and communicating the at least one condition from the monitoring system to the robot control system. Thus, the safety configuration communicated from the monitoring system to the robot control system may further comprise the at least one condition associated with each geometric region. Each pair of geometric region and at least one condition associated with the geometric region is a safety constraint. A plurality of such safety constraints may be provided by the monitoring system and communicated to the robot control system.

As a possible alternative, the at least one condition for each geometric region may be predefined and may therefore not need to be communicated to from the monitoring system to the robot control system. Examples of such predefined conditions are a prevention of the industrial robot to enter the geometric region and a full stop of the industrial region when the at least one condition is triggered.

The at least one condition may be triggered or activated by an event. The event may be of various types. The at least one condition may be activated by the presence of the industrial robot or an object inside the geometric region. Each condition may thus have a status of either active or passive. The method may further comprise determining a movement of the industrial robot by the robot control system based on the status of the at least one condition.

The at least one condition may comprise a limitation of an operation parameter of the industrial robot. Examples of operation parameters include speed, acceleration, force, torque, temperature and payload.

The method may further comprise taking a countermeasure by the monitoring system in case the at least one condition is not fulfilled by the industrial robot. Although the geometric region is communicated by the monitoring system to the robot control system, the monitoring system will still monitor the execution of the movement with respect to the safety configuration and take a countermeasure in case the safety configuration is violated by the industrial robot. Examples of countermeasures include stopping the industrial robot, limiting an operation parameter of the industrial robot and issuing an alarm.

The method may further comprise performing an offline simulation of the determined movement with respect to the geometric region and the at least one condition prior to executing the movement. By means of the offline simulation, the robot program can be analyzed to see how it is affected by the safety configuration. If the speed has to be reduced or if the industrial robot has to stop in the geometric region in order to fulfill the at least one condition associated with the geometric region, the productivity of the industrial robot may be negatively affected. The robot programmer may thus make use of the simulation to improve the robot program with respect to the safety configuration. Moreover, by using the safety configuration as a basis for the offline simulation of the determined movement, time consuming simulations of movements that would violate the safety configuration can be avoided.

The determination of the movement may comprise a determination of a path of the industrial robot. To this end, the robot control system may comprise an automatic path planner that can automatically determine a path of the movement based on the geometric region and the at least one condition. A path and a trajectory are different in that a path is a geometric shape of a movement while a trajectory contains a particular behavior along a path. For example, a first trajectory may be a movement along a path at a first speed and a second trajectory, different from the first trajectory, may be a movement along the same path at a second speed, different from the first speed. The determination of the movement is thus not limited to a fixed movement geometry in this variant.

According to a second aspect, there is provided a system for handling safety of an industrial robot in a workspace, the system comprising a robot control system configured to control the industrial robot and a monitoring control system. The monitoring control system is configured to provide a geometric region, where the geometric region is defined in relation to the industrial robot and/or in relation to the workspace, and where the geometric region is associated with at least one condition for being fulfilled by the industrial robot; and communicate the geometric region to the robot control system. The robot control system is configured to determine a movement of the industrial robot based on the geometric region and the at least one condition; and command execution of the movement by the industrial robot. The monitoring control system is further configured to control monitoring of the execution of the movement with respect to the geometric region and the at least one condition.

The monitoring control system may be configured to provide the at least one condition; and communicate the at least one condition to the robot control system.

The at least one condition may become active when the industrial robot or an object enters the geometric region.

The at least one condition may comprise a limitation of an operation parameter of the industrial robot.

The monitoring control system may be configured to command a countermeasure in case the at least one condition is not fulfilled by the industrial robot.

The determination of the movement may comprise a determination of a path of the industrial robot.

The system may further comprise the industrial robot.

The system may further comprise a monitoring system, the monitoring system comprising the monitoring control system and a monitoring device for monitoring the workspace.

### BRIEF DESCRIPTION OF THE DRAWINGS

Further details, advantages and aspects of the present disclosure will become apparent from the following description taken in conjunction with the drawings, wherein:

FIG. 1: schematically represents a perspective view of a system comprising a monitoring system, an industrial robot and geometric regions;

FIG. 2: schematically represents a perspective view of the system after definition of a further geometric region;

FIG. 3: schematically represents a perspective view of the system when a human has entered one of the geometric regions;

FIG. 4a: schematically represents a top view of a system comprising a monitoring system, a further example of an industrial robot and a further example of a geometric region;

FIG. 4b: schematically represents a top view of the system in FIG. 4a when the industrial robot has entered the geometric region;

FIG. 5a: schematically represents a top view of a system comprising a monitoring system, an industrial robot and a further example of a geometric region; and

FIG. 5b: schematically represents a top view of the system in FIG. 5a when a human has entered the geometric region.

### DETAILED DESCRIPTION

In the following, a method of handling safety of an industrial robot in a workspace, and a system for handling safety of an industrial robot in a workspace, will be described. The same or similar reference numerals will be used to denote the same or similar structural features.

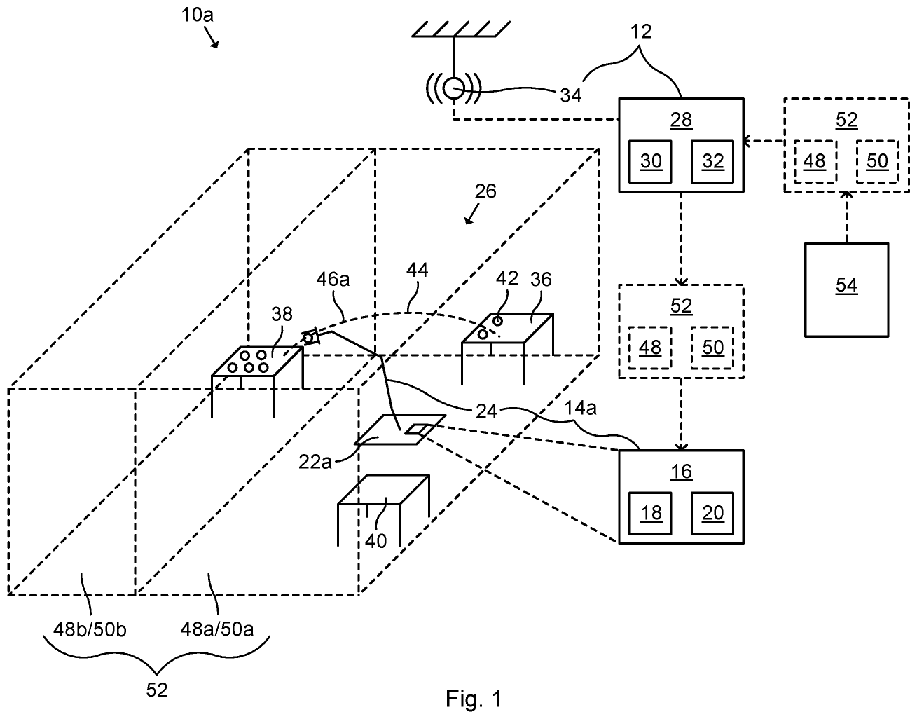

FIG. 1 schematically represents a perspective view of a system 10a. The system 10a comprises a monitoring system 12 and an industrial robot 14a.

The industrial robot 14a of comprises a robot control system 16 having a data processing device 18 and a memory 20. The memory 20 has a computer program stored thereon. The computer program comprises program code which, when executed by the data processing device 18, causes the data processing device 18 to perform, or command performance of, various steps as described herein. The robot control system 16 and the computer program are here a robot controller and a robot program, respectively. The robot program comprises a path planner.

The industrial robot 14a of this example further comprises a stationary base 22a and a manipulator 24 movable relative to the base 22a. The manipulator 24 is movable in three or more axes, such as in six or seven axes. The industrial robot 14a operates in a workspace 26.

The monitoring system 12 comprises a monitoring control system 28 having a data processing device 30 and a memory 32. The memory 32 has a computer program stored thereon. The computer program comprises program code which, when executed by the data processing device 30, causes the data processing device 30 to perform, or command performance of, various steps as described herein. The monitoring control system 28 of this example is a safety PLC (programmable logic controller).

The monitoring system 12 of this example further comprises a monitoring device 34. The monitoring device 34 is here exemplified as a lidar but may be another type of sensor configured to detect movements of the industrial robot 14a within the workspace 26. The monitoring device 34 is in signal communication with the monitoring control system 28. The monitoring system 12 may comprise a plurality of such monitoring devices 34.

The workspace 26 of this specific illustrative example contains a first table 36, a second table 38 and a third table 40. The industrial robot 14a here performs a task of picking items 42 one by one from the first table 36 and placing the items 42 one by one on the second table 38. To this end, the manipulator 24 performs a plurality of movements 44. A first path 46a between the first table 36 and the second table 38 is generally indicated in FIG. 1.

As shown in FIG. 1, the system 10a of this example does not comprise any physical fence. The workspace 26 is a collaborative workspace into which humans may enter. As shown in FIG. 1, a first geometric region 48a and a second geometric region 48b are defined in the workspace 26 (illustrated with dashed lines). The geometric regions 48a and 48b of this example are not visible by a human. Each geometric region 48a and 48b is here exemplified as a zone having a three-dimensional cuboid shape. In this specific example, the first geometric region 48a contains pick positions on the first table 36 and the second geometric region 48b contains place positions on the second table 38.

The first geometric region 48a is associated with at least one first condition 50a and the second geometric region 48b is associated with at least one second condition 50b. The first and second geometric regions 48a and 48b and the first and second conditions 50a and 50b form one example of a safety configuration 52.

The safety configuration 52 may initially be created in a computer 54, for example in the offline programming tool RobotStudio®, marketed by ABB. The safety configuration 52 has to be approved in view of safety regulations, such as various ISO standards, before being implemented in the monitoring system 12. The safety configuration 52 is then sent from the computer 54 to the monitoring system 12 for implementation in the monitoring control system 28, as illustrated in FIG. 1.

When the safety configuration 52 has been created, offline simulations of different movements complying with the safety configuration 52 can be performed. In this way, an operator can see how the operation of the industrial robot 14a is affected by the safety configuration 52. The simulation may for example be carried out in the computer 54 by means of the offline programming tool RobotStudio®.

The monitoring system 12 is an external system for supervising the industrial robot 14a (and optionally additional equipment within the workspace 26) to make sure that the industrial robot 14a follows the set safety configuration 52. One example of such safety system is SafeMove® marketed by ABB.

Reference numeral “48” represents one or more of the geometric regions and reference numeral “50 represents one or more of the conditions associated with the geometric regions. Although two geometric regions 48a and 48b are illustrated in FIG. 1, the workspace 26 may contain a substantially higher number of geometric regions.

Once the safety configuration 52 has been implemented in the monitoring control system 28, the monitoring system 12 monitors the workspace 26 in view of the safety configuration 52 during operation of the industrial robot 14a. If the conditions 50a and 50b are not met by the industrial robot 14a, the monitoring system 12 commands an emergency stop of the industrial robot 14a. The safety configuration 52 may be changed but this is often quite labor intensive in order to meet the safety regulations. The monitoring functionality of the monitoring system 12 as such is previously known.

The monitoring system 12 functions independently of the industrial robot 14a. With the introduction of the monitoring system 12 to the system 10a, no physical fence is needed. Instead, the safety supervision provided by the monitoring system 12 is used as protection. The monitoring system 12 may comprise duplicated software and hardware to ensure safety.

Each respective condition 50a and 50b should be imposed on the manipulator 24 when activated. In this specific example, the first condition 50a is a speed limitation of the manipulator 24 inside the first geometric region 48a when a human enters the second geometric region 48b. If no human is present in the first geometric region 48a or in the second geometric region 48b, the manipulator 24 is allowed to operate at full speed inside the first geometric region 48a. The first geometric region 48a may alternatively be an unconstrained region.

The second geometric region 48b is associated with second conditions 50b that the industrial robot 14a should immediately stop if a human enters the second geometric region 48b when the industrial robot 14a is inside the second geometric region 48b, that the industrial robot 14a is prevented from entering the second geometric region 48b when a human is inside the second geometric region 48b, and that the speed of the industrial robot 14a is limited when the industrial robot 14a is inside the second geometric region 48b and no human is inside the second geometric region 48b. The speed limitation may for example be set to maximum 200 mm/s.

When the manipulator 24 moves from the first geometric region 48a and into the second geometric region 48b in order to place an item 42 on the second table 38, the speed of the manipulator 24 is automatically limited. In this way, it can be avoided that the monitoring system 12 intervenes and commands the industrial robot 14a to stop. The position of the TCP of the manipulator 24 may in this case be decisive of whether the manipulator 24 is in the first geometric region 48a or in the second geometric region 48b.

Once the safety configuration 52 has been implemented in the monitoring control system 28, the safety configuration 52 (containing the definitions of the geometric regions 48a and 48b and the conditions 50a and 50b) is communicated from the monitoring control system 28 to the robot control system 16, as illustrated in FIG. 1. The safety configuration 52 is here wirelessly communicated from the monitoring control system 28 to the robot control system 16. In case the system 10a comprises a plurality of industrial robots, the monitoring control system 28 may share the safety configuration 52 with each industrial robot.

The safety configuration 52 is shared in a non-safe way from the monitoring control system 28 to the robot control system 16. That is, the communication of the safety configuration 52 from the monitoring control system 28 to the robot control system 16 does not have to be safety rated. The safety configuration 52 is communicated to the robot control system 16 as support for the robot control system 16 to fulfill the safety configuration 52. The safety functionality of the monitoring system 12 is however not affected by the communication of the safety configuration 52 from the monitoring control system 28 to the robot control system 16. The safety configuration 52 is used by the industrial robot 14a when planning paths and trajectories in the robot control system 16. The robot control system 16 is configured to automatically determine the movements 44 based on the geometric regions 48a and 48b and the respectively associated conditions 50a and 50b.

The functionality of the monitoring control system 28 and the monitoring device 34 may be safety rated, e.g. in compliance with various safety regulations. It might be time consuming and expensive to change the safety configuration 52 since the new safety configuration 52 has to be approved. The safety configuration 52 may for this reason not be changed very frequently, for example at an interval of at least 1 day. The communication of the safety configuration 52 from the monitoring control system 28 to the robot control system 16 on the other hand, does not have to be safety rated.

By determining the movement 44 of the manipulator 24 based on the safety configuration 52, it is possible to avoid triggering a countermeasure by monitoring system 12. For example, forbidden regions can be avoided and speed can be reduced in regions where a limit is set in the safety configuration 52. By letting the robot control system 16 handle the constraints, it is possible to change the safety configuration 52 without having to manually update the robot program. The robot control system 16 may for example automatically adjust the speed when a speed-limitation-region is extended.

Since the compliance with the safety configuration 52 is supervised by the monitoring system 12, the handling of the safety configuration 52 by the robot control system 16 may be referred to as “non-safe”. There is thus no safety rating of the robot control system 16.

Although the industrial robot 14a can potentially be programmed to perform a movement violating the safety configuration 52, the industrial robot 14a will immediately be automatically stopped by the monitoring system 12 when executing such movement. However, the communication of the safety configuration 52 to the robot control system 16 saves time for manual programming.

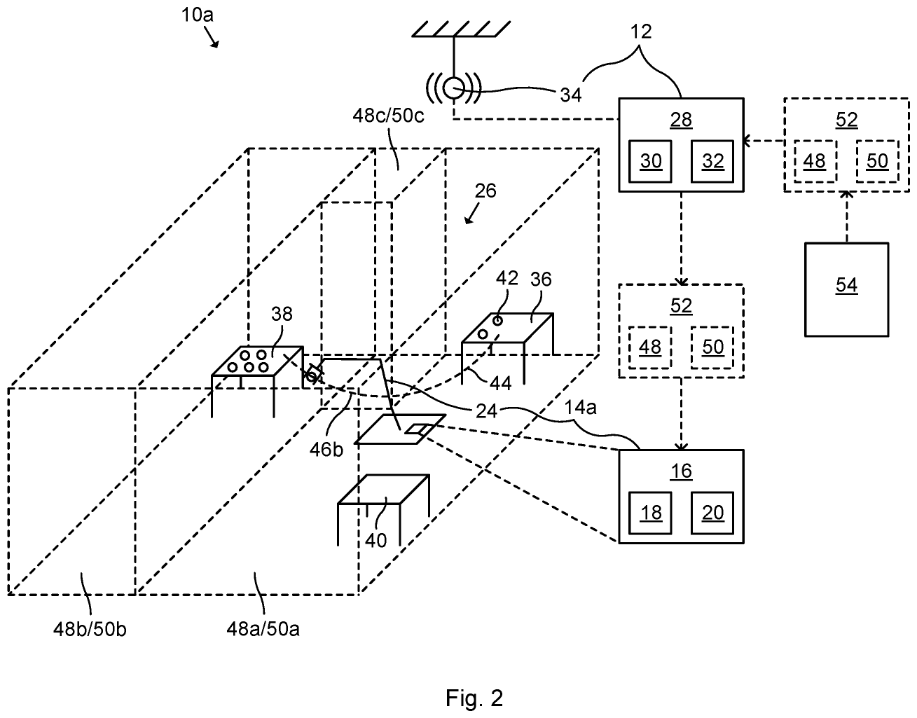

FIG. 2 schematically represents a perspective view of the system 10a after modification of the safety configuration 52. The safety configuration 52 has been modified by addition of a third geometric region 48c and an associated third condition 50c. As for the geometric regions 48a and 48b, the third geometric region 48c has been created in the computer 54 and sent to the monitoring control system 28 for implementation. The third geometric region 48c is a forbidden region (zero velocity region). Thus, the third condition 50c implies that the manipulator 24 under no circumstance is allowed to enter the third geometric region 48c. Also the third geometric region 48c is here exemplified as a zone having a three-dimensional cuboid shape. The updated safety configuration 52 now containing the geometric regions 48a-48c and the associated conditions 50a-50c is communicated from the monitoring control system 28 to the robot control system 16.

As can be gathered from FIGS. 1 and 2, the manipulator 24 can no longer move between the first table 36 and the second table 38 along the first path 46a without entering the third geometric region 48c to thereby violate the safety configuration 52 and cause an immediate emergency stop. Instead of manually defining the updated safety configuration 52 in the robot control system 16 and manually adjusting the robot program, the robot control system 16 receives the updated safety configuration 52 from the monitoring control system 28 and automatically replans the movement 44 between the first table 36 and the second table 38 based on the updated safety configuration 52. As shown in FIG. 2, the manipulator 24 can move along a second path 46b, different from the first path 46a, between the first table 36 and the second table 38 without violating the updated safety configuration 52. The robot control system 16 thereby commands the manipulator 24 to move along the second path 46b to continue the pick and place operation. Thus, by communicating the third geometric region 48c from the monitoring control system 28 to the robot control system 16, path programming of the industrial robot 14a becomes more effective.

Since the safety configuration 52 is updated in the monitoring system 12 and then sent to the robot control system 16, no manual reprogramming has to be made in response to the update of the safety configuration 52. The method thus enables the movement 44 to be automatically updated by changing from the first path 46a to the second path 46b to avoid triggering an emergency stop commanded by the monitoring system 12 while still completing the pick and place task. Triggering of a countermeasure by the monitoring system 12 is avoided by using the information in the safety configuration 52 in the path and trajectory planning in the robot control system 16. The system 10a thus provides automatic replanning capabilities based on sharing the safety configuration 52 with the robot control system 16. The robot control system 16 may for example determine the movement 44 based on the safety configuration 52 by solving an optimization problem, e.g. to find a time optimal trajectory in view of the safety configuration 52.

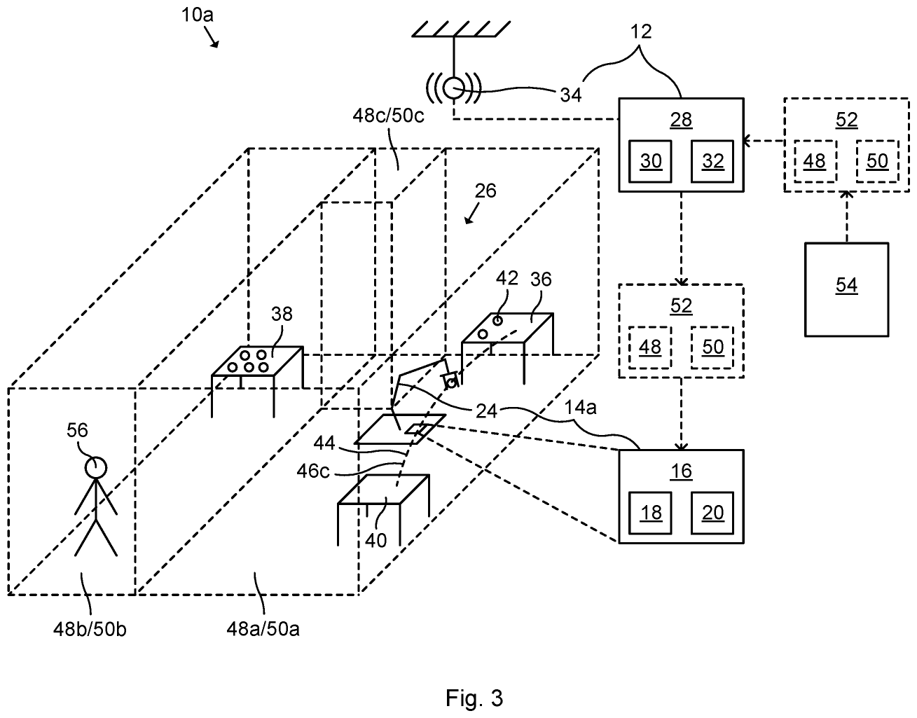

FIG. 3 schematically represents a perspective view of the system 10a when a human 56 has entered the second geometric region 48b, e.g. to inspect or pick items 42 from the second table 38. The status of one of the second conditions 50b thereby changes from passive to active. When the human 56 is present inside the second geometric region 48b, the second geometric region 48b becomes a forbidden zone. One of the second conditions 50b may alternatively be activated by entry of an object other than a human (such as another industrial robot) into the second geometric region 48b.

Due to the entry of the human 56 into the second geometric region 48c, the status of one of the second conditions 50b changes from speed limitation to forbidden. In case the manipulator 24 is inside the second geometric region 48b when the human 56 enters the second geometric region 48b, the manipulator 24 will immediately stop. In case the manipulator 24 is outside the second geometric region 48b, the manipulator 24 will be prevented from entering the second geometric region 48b.

Since one of the second conditions 50b associated with the second geometric region 48b is now active such that the manipulator 24 cannot enter the second geometric region 48b, the manipulator 24 can no longer move items 42 from the first table 36 to the second table 38. The robot control system 16 automatically determines a movement 44 of the industrial robot 14a based on the active status of one of the second conditions 50b. In this example, the robot control system 16 automatically determines a movement 44 along a third path 46c between the first table 36 and the third table 40. The industrial robot 14a can thereby perform an alternative task of picking items 42 from the first table 36 and placing the items 42 on the third table 40. Once the human 56 has left the second geometric region 48b, the industrial robot 14a resumes the pick and place operation along the second path 46b between the first table 36 and the second table 38. By using also the status of the conditions 50 to automatically determine the movement 44 by the robot control system 16 in this way, the ease of use and the work efficiency are further improved.

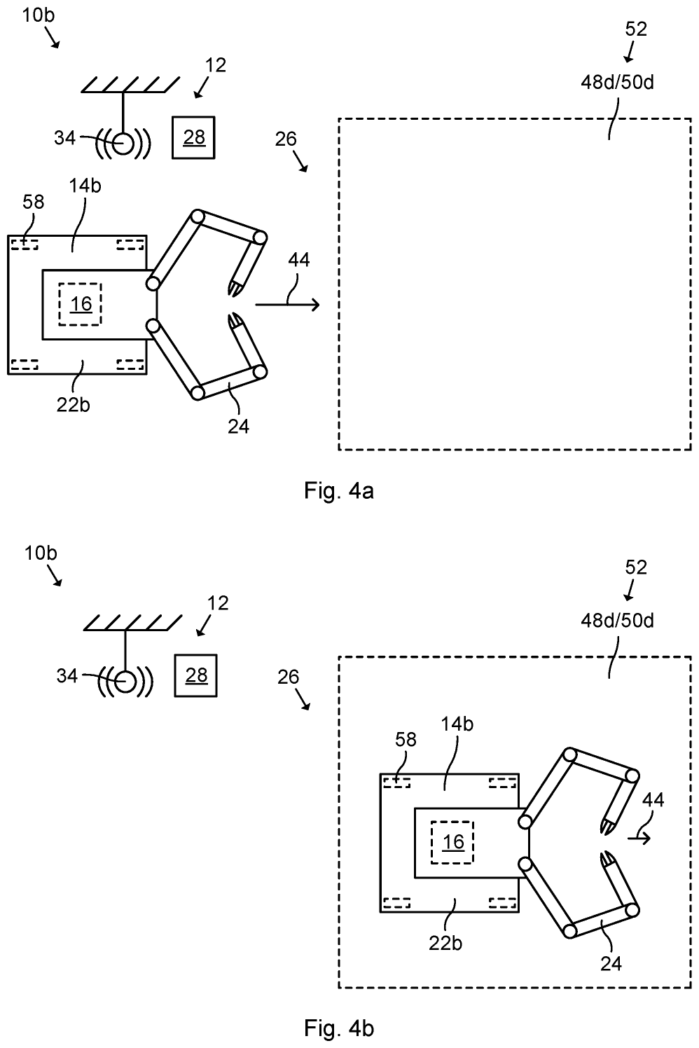

FIG. 4a schematically represents a top view of a system 10b comprising the monitoring system 12, a further example of an industrial robot 14b and a further example of a geometric region 48d. Mainly differences with respect to FIGS. 1 to 3 will be described.

The industrial robot 14b is a mobile robot. The industrial robot 14b comprises a base 22b. The base 22b is here exemplified as an automated guided vehicle, AGV. The base 22b comprises a plurality of wheels 58. The industrial robot 14b of this specific example further comprises two manipulators 24 movable relative to the base 22b.

The geometric region 48d is defined in relation to the workspace 26. Thus, the industrial robot 14b can move relative to the geometric region 48d. The geometric region 48d is associated with a condition 50d. The condition 50d of this example implies that the travel speed of the industrial robot 14b and the movement speed of each manipulator 24 are reduced when the industrial robot 14b is inside the geometric region 48d. In FIG. 4a, the industrial robot 14b is outside the geometric region 48d and no speed limitations are therefore imposed on the industrial robot 14b.

FIG. 4b schematically represents a top view of the system 10b in FIG. 4a when the industrial robot 14b has entered the geometric region 48d. The position of the base 22b of the industrial robot 14b may in this case be decisive of whether the manipulator 24 is inside the geometric region 48d. When the industrial robot 14b is inside the geometric region 48d, the travel speed of the industrial robot 14b and the movement speed of each manipulator 24 are reduced to avoid triggering the emergency stop from the monitoring system 12. Also in this example, the safety configuration 52 set in the monitoring system 12 is communicated to the robot control system 16 and the robot control system 16 automatically determines a movement 44 based on the safety configuration 52.

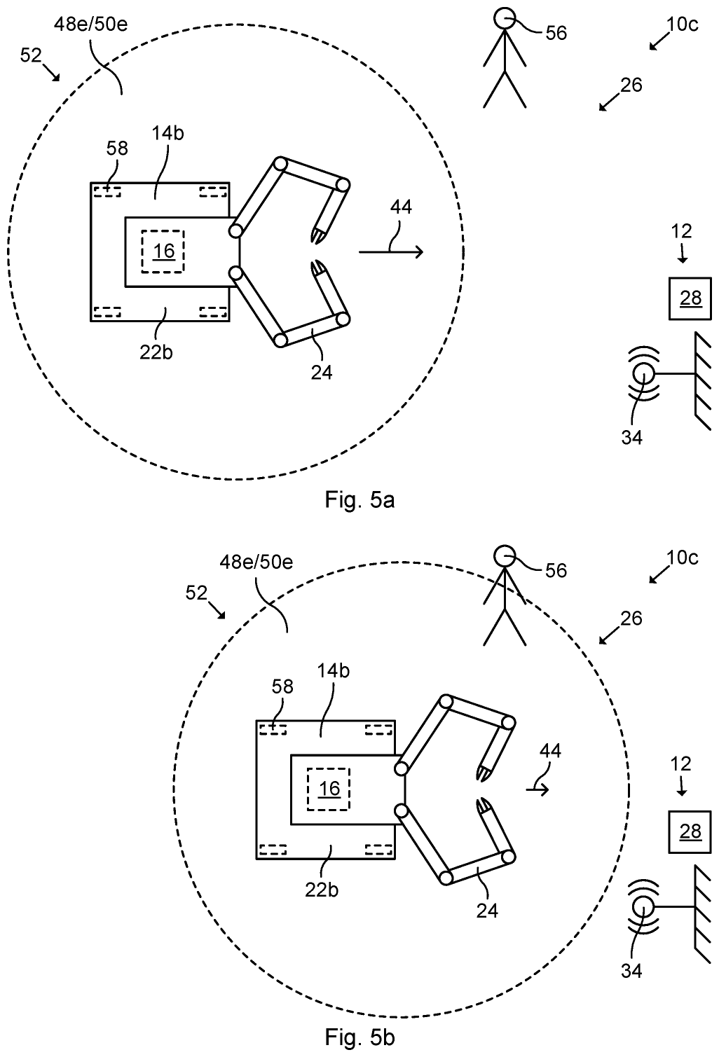

FIG. 5a schematically represents a top view of a system 10c comprising a monitoring system 12, an industrial robot 14b and a further example of a geometric region 48e. Mainly differences with respect to FIGS. 4a to 4b will be described.

In this example, the geometric region 48e is defined in relation to the industrial robot 14b. The geometric region 48e of this example is a sphere centered on the industrial robot 14b. When the industrial robot 14b moves, the geometric region 48e moves along with the industrial robot 14b. The geometric region 48e is associated with a condition 50e. The condition 50e implies that the travel speed of the industrial robot 14b and the movement speed of each manipulator 24 are reduced when a human 56 (or other object) enters the geometric region 48e. In FIG. 5a, the human 56 is outside the geometric region 48e and no speed limitations are therefore imposed on the industrial robot 14b.

FIG. 5b schematically represents a top view of the system 10c in FIG. 5a when a human 56 has entered the geometric region 48e. Although the human 56 has remained stationary in this example, the industrial robot 14b has traveled such that the human 56 has come inside the geometric region 48e. When the human 56 is inside the geometric region 48e, the travel speed of the industrial robot 14b and the movement speed of each manipulator 24 are reduced to avoid triggering the emergency stop from the monitoring system 12. Also in this example, the safety configuration 52 set in the monitoring system 12 is communicated to the robot control system 16 and the robot control system 16 automatically determines a movement 44 based on the safety configuration 52.

As a further alternative to the industrial robot 14a with a stationary base 22a and the movable industrial robot 14b, an industrial robot according to the present disclosure may be movable along a track.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of handling safety of an industrial robot in a workspace, the method comprising:
providing a geometric region by a monitoring system, where the geometric region is defined in relation to the industrial robot and/or in relation to the workspace, and where the geometric region is associated with at least one condition for being fulfilled by the industrial robot;
communicating the geometric region from the monitoring system to a robot control system of the industrial robot;
determining a movement of the industrial robot by the robot control system based on the geometric region and the at least one condition;
executing the movement by the industrial robot; and
monitoring, by the monitoring system, the execution of the movement with respect to the geometric region and the at least one condition.

2. The method according to claim 1, further comprising:
providing the at least one condition by the monitoring system; and
communicating the at least one condition from the monitoring system to the robot control system.

3. The method according to claim 1, wherein the at least one condition becomes active when the industrial robot or an object enters the geometric region.

4. The method according to claim 1, wherein the at least one condition comprises a limitation of an operation parameter of the industrial robot.

5. The method according to claim 1, further comprising taking a countermeasure by the monitoring system in case the at least one condition is not fulfilled by the industrial robot.

6. The method according to claim 1, further comprising performing an offline simulation of the determined movement with respect to the geometric region and the at least one condition prior to executing the movement.

7. The method according to claim 1, wherein the determination of the movement comprises a determination of a path of the industrial robot.

8. A system for handling safety of an industrial robot in a workspace, the system comprising:
a robot control system configured to control the industrial robot;
a monitoring control system configured to:
provide a geometric region, where the geometric region is defined in relation to the industrial robot and/or in relation to the workspace, and where the geometric region is associated with at least one condition for being fulfilled by the industrial robot; and
communicate the geometric region to the robot control system;
wherein the robot control system is configured to:
determine a movement of the industrial robot based on the geometric region and the at least one condition; and
command execution of the movement by the industrial robot; and
wherein the monitoring control system is further configured to control monitoring of the execution of the movement with respect to the geometric region and the at least one condition.

9. The system according to claim 8, wherein the monitoring control system is configured to:
provide the at least one condition; and
communicate the at least one condition to the robot control system.

10. The system according to claim 8, wherein the at least one condition becomes active when the industrial robot or an object enters the geometric region.

11. The system according to claim 8, wherein the at least one condition includes a limitation of an operation parameter of the industrial robot.

12. The system according to claim 8, wherein the monitoring control system is configured to command a countermeasure in case the at least one condition is not fulfilled by the industrial robot.

13. The system according to claim 8, wherein the determination of the movement a determination of a path of the industrial robot.

14. The system according to claim 8, further comprising the industrial robot.

15. The system according to claim 8, further comprising a monitoring system, the monitoring system including the monitoring control system and a monitoring device for monitoring the workspace.

16. The method according to claim 2, wherein the at least one condition becomes active when the industrial robot or an object enters the geometric region.

17. The method according to claim 2, wherein the at least one condition comprises a limitation of an operation parameter of the industrial robot.

18. The method according to claim 2, wherein the at least one condition comprises a limitation of an operation parameter of the industrial robot.

19. The method according to claim 2, further comprising performing an offline simulation of the determined movement with respect to the geometric region and the at least one condition prior to executing the movement.
